(19) United States
(12) Patent Application Publication
(10) Pub. No.: US 2004/0019494 A1
(43) Pub. Date: Jan. 29, 2004

(54) System and method for sharing information relating to supply chain transactions in multiple environments

(75) Inventors: Lindsay Ridgeway, Laytonsville, MD (US); Mark Patterson, (US); Mark Kushner, (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Manugistics, Inc.

(21) Appl. No.: 10/355,256

(22) Filed: Jan. 31, 2003

Related U.S. Application Data
(60) Provisional application No. 60/377,203, filed on May 3, 2002.

(51) Int. Cl. G06F 17/60

(52) U.S. Cl. 705/1; 705/10

(57) ABSTRACT

A system and method for sharing information relating to supply chain transactions and marketing data in either sell-side or buy-side environments. The system includes the ability to share information relating to ERP functionalities, surveys, target marketing and catalogs between multiple supply chain trading partners. Users of the system may elect to activate only certain functionalities and features based on their particular preferences.

### CROSS REFERENCE TO RELATED APPLICATIONS

This application claims priority from co-pending commonly assigned U.S. Provisional Patent Application Serial No. 60/377,203 filed May 3, 2002, the disclosure of which is hereby incorporated by reference in its entirety.

### BACKGROUND OF THE INVENTION

1. Field of the Invention

The present invention relates to a system and method for managing and sharing information between sellers and buyers. Specifically, it relates to a system and method that is web based and allows either supply chain sellers or buyers to be the host administrator for processing and sharing of a broad range of supply chain information.

2. Description of Related Art

Today's companies face several problems with respect to order management. Order management may be defined as the managing and sharing of information related to all aspects of buyer-seller transactions and relations. Most enterprises have multiple disparate and distributed back-end systems that make the sharing of rapidly changing information relating to all aspects of business transactions complex, confusing, labor intensive and costly. In addition, order processing costs are typically very high using conventional means of processing orders. Enterprises need to sell across multiple channels, for example, through catalogs, the Internet, distributors, and retailers and still provide full service to their customers. Unfortunately this is often not the case with conventional order management systems, especially when ordering is conducted over the Internet. Further, it may take multiple applications to provide the various information sharing needs of a supply chain enterprise.

Supply chains tend to be highly complex involving numerous participants with multiple criss-crossing relationships. For any sizable supply chain, a large number of commercial transactions typically occur on any given day. These commercial transactions may be divided into at least two groups, indirect material procurement and direct material procurement transactions. Indirect material procurements are transactions that generally involve items that are finished goods (e.g., pens, paper, desktop computer, and the like). Indirect material procurement generally occurs at or near the bottom of the supply chain (e.g., close to or at the retail level). Direct material procurements, on the other hand, are transactions that usually involve raw materials or component parts and is usually transactions that occur at the upper levels of a supply chain.

Approaches for sharing information relating to indirect, as opposed to direct material procurement, are often substantially different. The information relating to indirect material procurement transactions tend to be somewhat static and therefore, generally easy to exchange between supply chain buyers and sellers involved in indirect material procurement. This is because the information relating to, for example, catalogs, orders, pricing, and the like, tend to remain constant. Further, supply chain partners involved in indirect material procurement typically do not have a strong need to obtain or disseminate the wide range of information shared by those involved in direct material procurement. In contrast, information shared by supply chain partners involved in direct material procurements tends to be highly dynamic. Information relating to direct material procurement typically involves information related to solving sourcing problems. For example, large manufacturers generally need to be able share information relating to purchasing transactions with suppliers supplying component materials. In these situations, the process for procurement may be very precise requiring information such as Request for Pricing (“RFP”) and Request for Quotes (“RFQ”) or information relating to preferred or qualified suppliers to be exchanged among specific supply chain partners. Thus, direct material procurement transactions often involve negotiations for pricing, product specifications, services and the like, and may involve orders involving large volumes of order goods. Further, each transaction may be customer or order specific. Thus, even information relating to, for example, catalogs, may be specific to a customer, a transaction, a location, and the like. Therefore, a system for sharing transactional information for direct material procurement will generally need to be significantly more flexible than those for indirect material procurement transactions.

Supply chain participants typically deal with numerous supply chain partners at any given time. These supply chain partners may be either a buyer or a seller of goods and services. Unfortunately conventional purchase order management systems are generally implemented so that they operate only in a sell-side environment. In other words, the conventional systems are typically designed so that the host and/or administrator of the system is a seller rather than a buyer. Therefore, supply chain participants may need to use two systems, an order management system, for sharing information relating to transactions in which the participant is the seller, and a purchase order management system, to facilitate the exchange of information related to any transaction where the participant is the buyer.

One of the biggest impacts that the introduction of the Internet has had on commerce is the compression of order cycle times. Instead of the order to cash cycle taking weeks as in the past, many companies are turning orders into shipments in days and even hours in some cases. As a result, many customers are beginning to expect and even demand a quick turnaround on their orders. As service becomes the key differentiator, being able to deliver on this demand is a competitive necessity. It can mean the difference between making or losing the sale. Conventional order management systems often are highly inefficient and often very slow when integrated with backend systems. Both sellers and buyers want to be able to share information relating to all aspects of supply chain business transactions including ordering, inventory, marketing price quotations, and the like. Thus, a system that allows supply chain customers and sellers to share, in real time and via an electronic network, information relating to any supply chain purchasing transactions, will be highly desirable. Further, it would be highly desirable for such a system to be able to fully integrate with backend systems providing complete end-to-end solutions. Further still, it is highly desirable to have one system, which may be implemented by either a buyer and/or seller for sharing business transaction information.

### SUMMARY OF THE INVENTION

Accordingly, the present invention is directed to a system and method for processing and sharing of information between buyers and suppliers. More specifically, a highly dynamic system and method for processing of information relating to customer orders, catalogs, surveys, and the like, and which may be implemented by any supply chain partner regardless of the identity of the host.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

According to one embodiment of the present invention, a true 24/7 purchase/order management system (“OM System”) is provided that allows businesses to process, fulfill, and manage orders electronically and in real-time over an electronic network such as the Internet by either a seller or a buyer host administrator. The system may connect internal and external selling organizations and supply chain partners to order and inventory information stored in back-end systems. The system may resolve its 24/7 availability conflict with back end systems (which often must be shut down for extended periods) by providing order-caching feature that allows customers to place orders, eve if the back-end system is down. When a back-end system is down, the order management system may store orders in the application database and when the back-end system is back online, those orders are then submitted to the back-end system and confirmations are sent. The system may allow customers to search catalogs, check product availability, and track

According to another embodiment of the present invention, the OM System is an electronic channel using the World Wide Web that may automate the entire ordering process for both buyers and sellers. A significant portion of a commercial transaction in a supply chain may be automated, for example, the system may automate the order management process relating to marketing, selling and supporting activities of trading partners.

According to another embodiment of the present invention, unlike conventional order management systems that are implemented in a sell-side environment, the system according to the present invention may be implemented both in sell-side and buy-side environments. The ability to operate either in a buy-side or sell-side environments means that the system according to the present invention is a highly robust and flexible system.

According to another embodiment of the present invention, the OM System allows for marketing, sales, and trading partners to fill orders, check order status, and access both product inventory and product price information. The OM System may also allow sellers to create, maintain and display catalogs to buyers regardless of whether the OM System is implemented as a buy-side or sell-side solution. Such a feature may even be implemented in a buy-side environment.

According to another embodiment of the present invention, the OM System is a business-to-business software application that supports enrollment and password protection, includes the capability of customer-specific pricing, bills to a PO number, and contains ship-to and bill-to defaults. The system may also contain complete catalog products. Security may also be implemented by the use of user hierarchies.

According to another embodiment of the present invention, a method and system for sharing supply chain information relating to supply chain transactions and marketing capable of being implemented by a supply chain trading partner in both sell-side and buy-side environments is provided. The system provides such capabilities by following certain steps. First by defining a host and users, the host being either a seller or a buyer; activating at least two functionalities where at least the two functionalities are ERP and catalog sharing functionalities, creating at least one partnership between the host and at least one of the users, the at least one partnership defining rules relating to said at least two functionalities, and implementing an action based on one of the functionalities.

According to another embodiment of the invention, the system may incorporate the step of creating an optional feature, wherein the optional feature is providing at least one of RFP, RFQ, and returns features.

According to another embodiment of the invention, the ERP functionality includes the ability to provide order approval functionality.

According to another embodiment of the invention, the system and method may incorporate the step of inputting data for the functionalities.

According to another embodiment, the step of creating a partnership comprises the steps of creating a partnership ID, identifying partnership members and selecting partnership function. The method may further comprise the steps of creating a partnership rule and mapping said rule to said partnership.

According to another embodiment of the present invention, hierarchies may be created.

According to another embodiment of the present invention, in order to provide the catalog sharing functionality, the step of mapping at least one item is used.

According to another embodiment of the present invention, in order to provide the catalog sharing functionality, the step of loading a catalog from a seller's back-end system is used.

To achieve these and other advantages and in accordance with the purpose of the present invention, as embodied and broadly described, the purchase order system and method provides a single solution regardless of whether it is implemented in a supply-side or buy-side environment.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 is a block diagram depicting a system in accordance to an embodiment of the present invention in communication with a host and a plurality of users;

FIG. 2A is an exemplary illustration of a one-to-many relationship between a seller and a plurality of buyers;

FIG. 2B is an exemplary illustration of a one-to-many relationship between a buyer and a plurality of sellers;

FIG. 3 is a flow diagram depicting the steps for sharing and processing information between supply chain participants implemented by a host who may be either a buyer or a seller;

FIG. 4 is a flow diagram for defining users, host and functionalities;

FIG. 5 is a flow diagram for creating partnerships;

FIG. 6 is a flow diagram for inputting base data for a functionality;

FIG. 7 is a flow diagram for implementing an action;

FIG. 8 is a block diagram for an exemplary organizational chart;

FIG. 9 is a block diagram of an exemplary account, associated profiles and its sub-accounts;

FIG. 10 is a flow diagram for implementing target marketing; and

FIG. 11 is a flow diagram for implementing a promotion.

### DETAILED DESCRIPTION OF THE PREFERRED EMBODIMENTS

Reference will now be made in detail to the preferred embodiment of the present invention, examples of which are illustrated in the accompanying drawings.

The invention disclosed herein incorporates by reference the subject matter of co-pending commonly assigned U.S. Non-Provisional Patent Applications “System and Method for Supply Chain Management, Including Collaboration,” Zarefoss et al., Attorney Docket Number 82001-0189, application Ser. No. 09/965,854, filed on Oct. 1, 2001; “System and Method of Monitoring Supply Chain Parameters,” Zarefoss et. al., Attorney Docket Number 82001-0199, application Ser. No. 09/984,340, filed Oct. 29, 2001; “System and Method for Supply Chain Demand Planning and Forecasting,” Singh et al., Attorney Docket Number 82001-0193, application Ser. No. 09/984,347, filed Oct. 29, 2001; “Network Transport System and Method with Freight Payment Module,” Aruapuram et al., Attorney Docket Number 82001-0123, application Ser. No. 09/.882,257, filed Jun. 18, 2001; “System and Method for Ensuring Order Fulfillment,” Jenkins et al., Attorney Docket Number 82001-0197, application Ser. No. 09/984,349, filed Oct. 29, 2000; “System and Method for Managing Market Activities, Zarefoss et al., Attorney Docket Number 82001.0328, application No. 60/336,147 filed on Dec. 6, 2001; “Promotion Pricing System and Method,” Scott et al., Attorney Docket Number 82001.0317, application Ser. No. 09/987,706, filed on Nov. 15, 2001; “Target Pricing Method,” Boyd et al., Attorney Docket Number 82001.0312, application Ser. No. 09/517,977, filed on Mar. 3, 2000; “Target Pricing System,” Boyd et al., Attorney Docket Number 82001.0313, application Ser. No. 09/517,983, filed on Mar. 3, 2000; “System and Method for Integrating Disparate Networks for Use in Electronic Communication and Commerce,” Shannon et al., Attorney Docket Number 82001.0191, application Ser. No. 09/927,412, filed on Aug. 13, 2001; “Dynamic Pricing System,” Phillips et al., Attorney Docket Number 82001.0310, application Ser. No. 09/859,674, filed May 18, 2001; “System and Method for Enabling Collaborative Procurement of Product in a Supply Chain,” Zarefoss et al, Attorney Docket Number 82001.0296, application Ser. No. 10/014,789, filed Dec. 14, 2001; and “System and Method for Viewing Supply chain Network Metrics,” Kavounis et al., Attorney Docket Number 82001.0195, application Ser. No. 10/059,05, filed Jan. 30, 2002.

The present invention provides an order management (“OM”) system, which allows supply chain partners to share supply chain transactional information in either a sell-side or buy-side environment. The OM System may be implemented side-by-side with other logistical applications, for example, a supply chain information sharing application such as described in co-pending commonly assigned U.S. Non-Provisional patent application Ser. No. 09/965,854, “System and Method for Supply Chain Management Including Collaboration.” The advantage of operating the OM System side-by-side with such systems is that it allows the applications to share information, such as partnerships and hierarchy information, needed to efficiently perform the various functionalities of each application and thus reducing memory requirements.

The present invention provides for an Order Execution & Management system (i.e., OM System), which may be implemented by a sales organization or a procurement organization to facilitate the execution of and collaboration on a broad range of supply chain transactions between supply chain partners. Such information includes, for example, sales orders [SO], purchase orders [PO], item catalogs, pricing, order modifications and cancellation, material returns, approval routings (approval chain required for an order to be executed), supplier response and feedback, requests for proposal [RFP] and requests for quote [RFQ], surveys, target marketing, and the like. The OM System may function independently of any other applications or may interface with other logistical applications, for example, the systems described in co-pending commonly assigned U.S. Non-Provisional patent applications numbers, 10/014,789, 09/965,854, 09/084,340, 10/059,055, 09/927,412 and co-pending commonly assigned U.S. provisional patent application No. 60/336,147, to provide full logistical capabilities to its users. The OM System may be implemented using a combination of both hardware and software, and an electronic network such as the Internet, intranet, LAN, WAN, and the like.

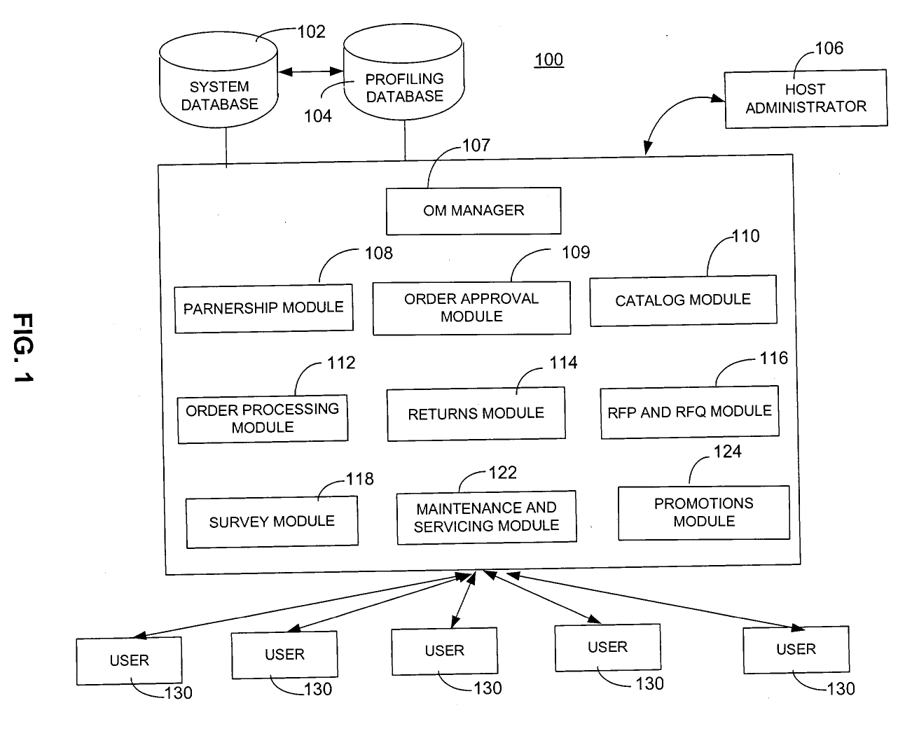

Referring to FIG. 1, which is a block diagram of an exemplary OM System 100 according to one embodiment of the present invention. The OM System 100 includes a system database 102 and an optional profiling database 104. Alternatively, the profiling database 104 and the system database 102 may reside in the same database. The profiling database 104 may contain profiling information of various system users and/or system features. For example, the OM System 100 may contain profiles for customers and accounts as well as for catalogs, surveys, returns and the like. A host administrator 106 is in electronic communication with the OM System 100. The OM System 100 is neutral to the identity of the host 102. Thus, the host 102 may be a buyer, a seller or any other supply chain participant. The OM System 100 may be located in a computer device such as PCs, workstations, servers or any other computer devices commonly known to those skilled in the art.

The OM System 100 may include a number of modules for performing various functions and features. The functions that may be available through the OM System 100 include, for example, catalog/pricing list sharing, ERP functionalities and catalog sharing. The features that may be available through the OM system 100 include order modification and cancellation, returns capability, Request For Price (“RFP”) and Request For Quote (“RFQ”) capabilities, and maintenance and services capabilities. Examples of the types of modules that may be included in the OM System 100 include a module for managing purchase orders 107, a partnership module 108, an order approval module 109, a catalog module 110, an order processing module 112, a returns module 114, a RFP and RFQ module 116, a survey module 118, a maintenance and services module 122 and a promotions module 124. These modules may provide multiple functions. For instance, the partnership module 108 may also be used to create hierarchies in addition to its ability to create and maintain partnerships. A number of other modules may also be included in the OM System 100. The OM System 100 is in electronic communication with users 130 via electronic network such as the Internet, Intranet, LAN, WAN, and the like. Users 130 may be any supply chain participants including buyers and sellers.

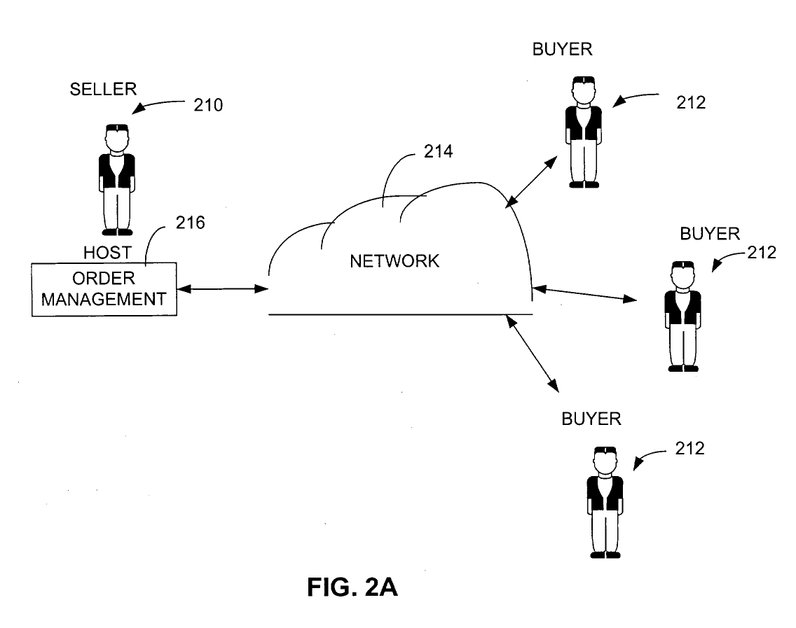

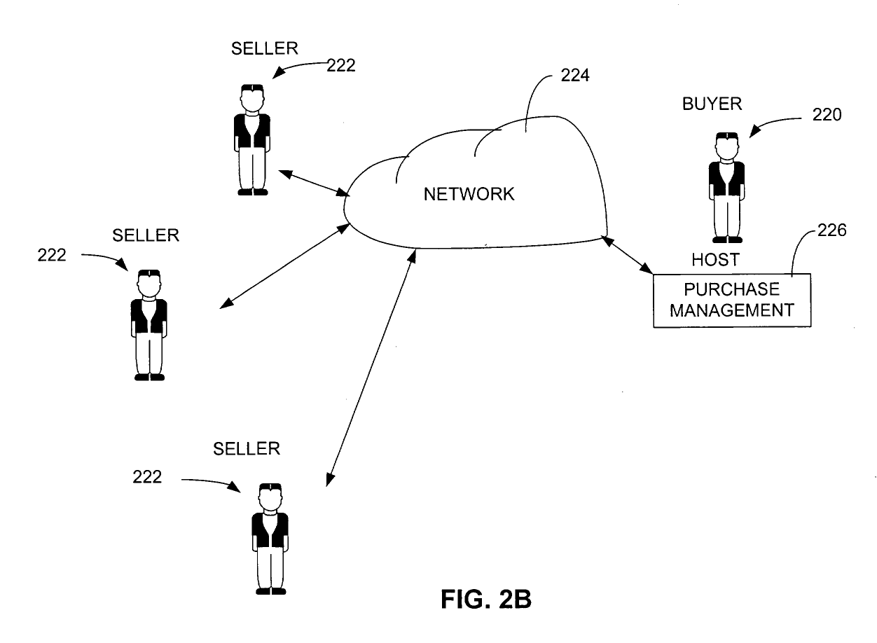

The OM System 100 supports many types of relationship configurations. For example, the OM System 100 supports one-to-many supply chain partner relationships. Referring now to FIGS. 2A and 2B, which are two types of one-to-many relationships that the OM System 100 supports. The two figures essentially represents sell-side (FIG. 2A) and buy-side (FIG. 2B) environments. In FIG. 2A, the host/administrator 210 for the OM System 100 is a seller. In this configuration, the OM System 100 supports a sales business process commonly referred to as Order Management as indicated by 216. The seller/host 210 is in electronic communication with buyer/users 212 via an electronic network 214. Typically the host will consist of users with the roles of system administrator or a seller who will have privileges and access to various system functions that may not be accessible by buyer users 212. In this embodiment, the OM System 100 resides with the seller/host 210 as indicated by 216. In FIG. 2B, the host/administrator 220 for the OM System 100 is a buyer. In this configuration, the OM System 100 supports a procurement business process commonly referred to as Purchase Management as indicated by 226. The buyer/host 220 is in electronic communication with seller/users 222 via an electronic network 224. As previously described, the host, in this case buyer 220, may include users with privileges and access to certain functionalities that may not be available to seller users 222. Users of the buyer 220 may be granted privileges and access via implementation of hierarchies. For instance, partnerships between buyers and sellers may be created which define the rights of each party. By defining a hierarchy for users associated with the buyer, privileges and access may flow to users at lower levels of the hierarchy. Note in a hierarchical relationship, partnership rules and rights will typically flow down the hierarchy. For instance, suppose there is a hierarchical relationship between a buyer1 and a buyer2 whereby buyer1 is at a higher level in the hierarchy than buyer2. Suppose further that buyer1 and a seller create a partnership setting up rules relating to catalogs. Buyer2 may then be automatically granted rights and privileges granted to buyer1 through the partnership. These rights created in partnerships of course are not limited to catalogs but also to rules relating to order creation and processing. In this embodiment, the OM System 100 resides with the buyer/host 220 as indicated by 226.

A buyer may have relationships with other buyers. Generally, a buyer can only have a hierarchical relationship with other buyers. Thus, those in the lower hierarchical structure can inherit the rights of a buyer at the higher end of the hierarchical structure. Buyers and sellers can develop partnerships. For example, suppose you have three buyers, buyer1, buyer2 and buyer3. Buyer1 is the highest in the hierarchy and has a relationship with lower level buyer2. Buyer2 is in the higher location of the hierarchy than buyer3. If buyer1 creates a partnership with seller 1 than some or all of the rules defined in the partnership between buyer1 and the seller may be inherited by buyer2 and buyer3. For example, the right to access catalogs. A more detailed discussion relating to hierarchies may be found in co-pending commonly assigned U.S. Non-Provisional Patent Application Attorney Docket No. 82001-0189.

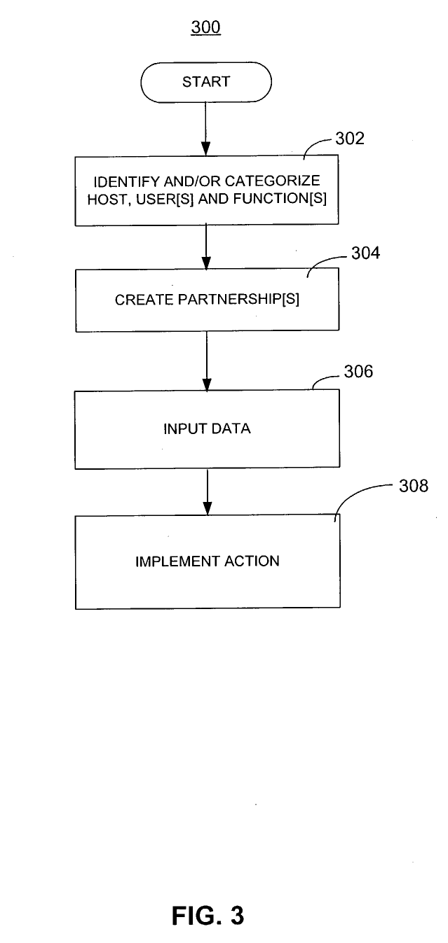

FIG. 3 illustrates a high-level process 300 according to one embodiment of the present invention for sharing supply chain information between supply chain participants. Initially, the roles of the participants (i.e., host and users) are identified and/or categorized and the available features are defined at step 302. A host's role may be as a buyer, a seller or any other customized roles. Based on the identity of the host and/or users, the OM System 100 may activate or deactivate selected functions. For example, the ability to create and share catalogs between sellers and buyers may be deactivated depending upon the particular situation that the system 100 is being implemented. For instance, users may elect not to implement catalog sharing between sellers and buyers depending upon whether the OM System 100 is operating in a buy-side or supply-side environment. Enterprise Resource Planning (“ERP”) functions, such as order generation, may also be deactivated depending upon the specific circumstances that the OM System 100 is being implemented. Next, partnerships may be created between participants at step 304 (i.e., host and users). Partnerships may be defined by business rules for the various functions that are provided by the OM System 100. Partnership rules may include rules such as rules for ordering, processing returns, publishing catalogs, order changing, canceling of orders, and the like. Such rules will define which actions will be allowable. If an action is allowable under the partnership then the partnership must also define the parameters surrounding the allowed action. One of the steps for the process 300 is to input data needed to implement actions at step 306. For example, inputting data needed to create a catalog and/or price list[s] for catalog sharing functions of the OM System 100. For order modification and cancellation, the data inputted is the modification and order rules so that modification or cancellation may be made to the order. Once rules have been configured and base data have been inputted, actions may be implemented. Actions are specific acts related to the functionalities provided by the OM System 100. For example, catalog retrieval is an action that is related to the catalog sharing function of the OM System 100. Other actions that may be available include, for example, submission of RFQ and RFP, filling out and submitting surveys, and the like. Each of the steps described above is described in greater detail below.

For each buyer or seller, hierarchies may be created. Typically a buyer or a seller will be an enterprise. Making up each buyer or seller are users. Hierarchies may be created to define the relationship between each user within a buyer or a seller. Generally, users at the lower end of a hierarchy will inherit the rights and privileges of users at higher levels of the same hierarchy.

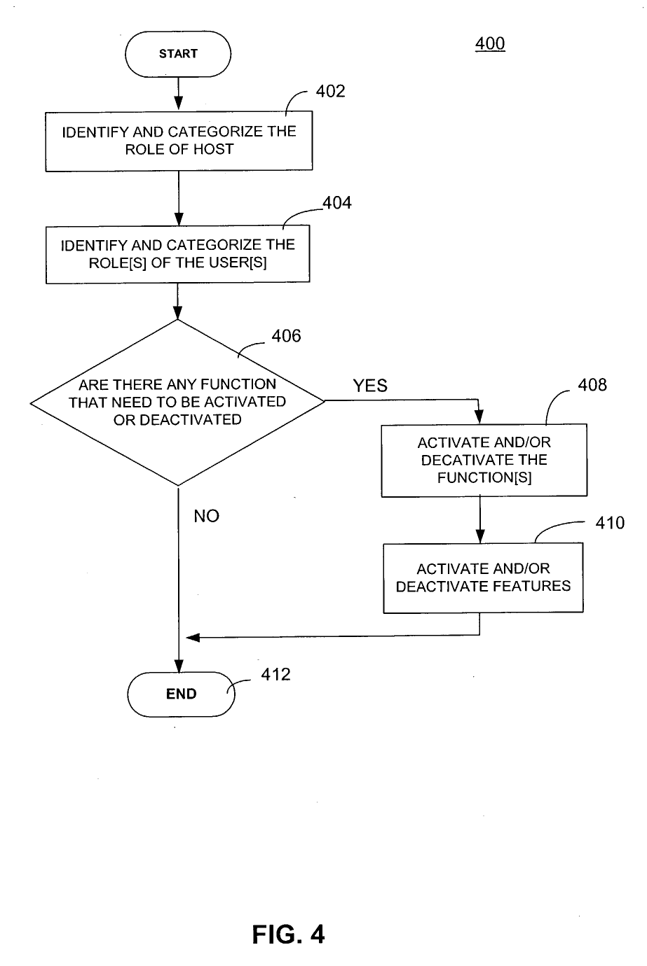

FIG. 4, is a process 400 for identifying and/or categorizing participants (i.e., user[s] and host) and activating/deactivating specific functionalities. The process 400 is an exemplary process for step 302 of FIG. 3. Initially, the host may be identified and categorize in step 402. There are at least two types of categories that the host may be categorized into, sellers and buyers. Next, user[s] may be identified and categorize as either a seller or a buyer at step 404. By categorizing each participant (i.e., host and users) as either a seller or a buyer and identifying each participant as a host or a user, the OM System 100 may provide customized user interfaces to each participant based on their roles and identities. Further, the roles and identities of each participant may dictate which functions and associated actions will be made available to each participant. The roles of the users may also define the user's access to data, functions and features. The user's role together with hierarchies is one way to control access to the various data and functionality provided by the OM system 100. Functions are capabilities of the OM System 100 such as catalog sharing, ERP functionalities, and the like. Although these functions may always be made available, the host and users (e.g., buyers and sellers) may elect to only use only certain functions. In order to implement these functions, the function may be activated. The decision to activate a function will generally depend on the desires of the host/administrators and/or users. Only certain functions may be made available for specific circumstances depending upon the identities of the users and host while other functions may be deactivated. Thus, a determination is made as to which function or functions are to be activated or deactivated at step 406. If one or more functions are to be activated and/or deactivated than the OM System 100 activates and/or deactivates those functions at step 408. Next, for each function activated, features associated with each function may be activated or deactivated at step 410. For instance, RFP and RFQ are features that are associated with ERP functionality that can be turned on or off. Another item that is a feature is order headers. For instance, certain attributes of an order header may be turned on and off. There could be an attribute for “payment method” in the order header, which could be turned “off” thus not showing how payment is to be made. The ability to create an order (which is a ERP functionality), on the other hand, is not a feature because it will always be available. Otherwise the process ends at 412.

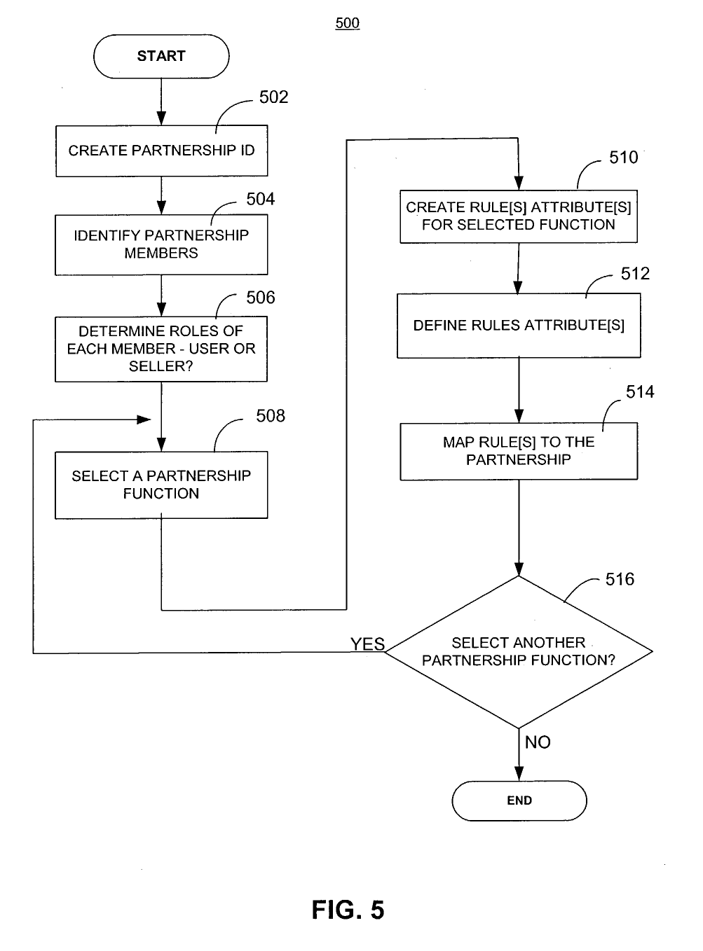

Referring to FIG. 5, which is a process 500 for creating a partnership. This process 500, in essence, represents step 304 of FIG. 3. Initially, a partnership ID is created at step 502. Preferably each partnership will have unique names so that each partnership may be individually retrieved. Moving to step 504, participants of the partnership are identified. General profiles of each participant may also be included when identifying each participant. For example, specific information relating to each participant such as location, associated products, and the like, may be identified and included in the general profile of each participant. The OM System 100 according to the present invention may maintain a number of special privileges to provide greater flexibility and comprehensive functionality. Alternatively, instead of maintaining profiles for each participant, a privilege profile may be created which allows access to the different features available through the OM system 100. Moving to step 504 where partnership members are identified. This means that the host and the users are all identified as members of the partnership created. Next, the role of each participant (e.g., whether a participant is a user or a host) is determined at step 506. In doing so, certain privileges may be automatically assigned to each of the participants based upon their assigned roles. For example, if a participant is assigned the role of a host, then that participant may have certain administrative rights not available to users such as creating new users, roles or enterprises. Moving to step 508 whereby a partnership function (e.g., catalog sharing, returns, order cancellation and modification surveys, and the like) is selected. At step 510, create rule attributes for the selected function. For example, if the selected function is for sharing a catalog, attributes such as shipping costs, effectivity dates warranty period, and the like, may be created. Once the rule attribute[s] is created, the rule attribute[s] is defined at step 512. For example, for a termination date attribute, a date may be provided for that attribute in step 512. Once the rule[s] has been created for the selected function, the rule[s] is then mapped to the appropriate partnership at step 514. If it is desirable to create rule[s] for another partnership function at step 516 then the process returns to step 508, otherwise the process 500 ends. In this case, rule set up may be for order change and cancellation defining how users and/or hosts may change or cancel orders.

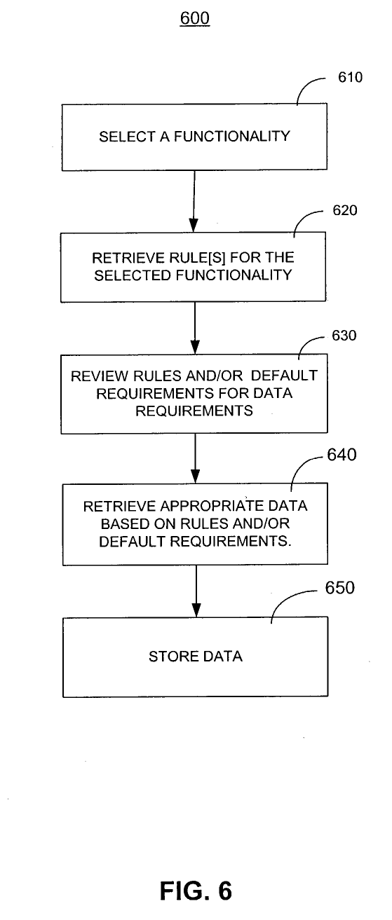

Returning to FIG. 3 where data is inputted at step 306, the approaches to inputting data will depend heavily on which functionalities are being implemented and what type of data is needed and/or added for the functionalities. For example, the types of data and the method for inputting data for creating catalogs and for order processing (e.g, order cancellation and modification) will differ significantly. However, the inputting of data will require taking the same generic steps for many of the functionalities available in the OM System 100. FIG. 6 is an exemplary process 600 for inputting base data. The base data is the data needed to implement an action. For example, if the action is to retrieve a catalog then the base data needed is the data for the catalog itself. Initially one of the functionalities available in the OM System 100 (i.e., catalog sharing, order modification and cancellation, surveys, target marketing, etc.) is selected at step 610. Once a function is selected, the rule or rules for the selected functionality is retrieved at step 620. The rule or rules is generally defined during the partnership step 304 in FIG. 3. After the rule or rules are retrieved, the rules or rules are reviewed and/or default requirements for the functionality are selected at step 630. Each function may have default requirements, which may be used as a basis for retrieving and/or processing retrieved data. Finally, the appropriate data is retrieved at step 640.

After the participants and the activated/deactivated functions have been defined, the partnerships created, and the appropriate data inputted, one or more actions may be implement as depicted in step 308 of FIG. 3. Actions are any acts performed under any of the functionalities provided by the OM System 100. For example, if the OM System 100 allows a seller's catalog to be viewed by a buyer than one possible action would be for a buyer to retrieve the catalog for viewing. Other possible actions are, for example, modification or cancellation of orders, submission of RFPs and RFQs and responding to the same, submission of returns form, distribution, filling-out and submission of surveys, exchange of information relating to target marketing, and the like.

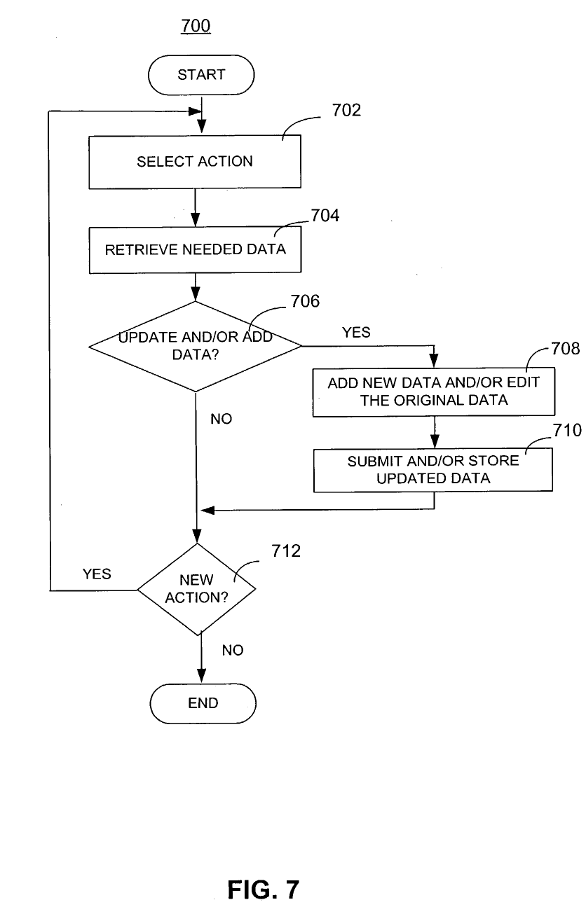

FIG. 7 is a process 700 for implementing an action through the OM System 100. This process 700 essentially represents step 308 of FIG. 3. Initially at step 702, an action is selected for implementation. Each course of action is typically associated with a specific function provided by the OM system 100. In order to implement an action, certain steps must be taken. For instance, the partnership that is associated with the action to be taken need to be retrieved to determine the rights of the action taker (e.g., buyer or seller). Once retrieved, the partnership is reviewed to determine those rights and if the desired action is allowed then the action may be implemented. Once an action is selected, needed data is retrieved at step 704. For example, for order cancellation and/or modification, the needed data retrieved would typically be the order and ordering rules; for surveys, the needed data retrieved would be the original unfilled survey forms; and the like. Moving to step 706, a determination is made as to whether the data retrieved needs to be updated or new data added. If the data needs to be updated or new data needs to be added then new data is added and/or the original data is edited at step 708. Moving to step 710 where the updated data is stored and/or submitted. For example, if the selected action were to modify an order than the updated order would likely be submitted to the seller and may also be stored in the database 102. Next, a determination is made as to whether another action is to be implemented at step 712. If indeed another action needs to be implemented then the entire process 700 is repeated, otherwise the process 700 ends.

To provide ERP functionality and to facilitate the processing of other functions, the OM System 100 may optionally create and define entities called “users” and “Enterprises.” Users, which may be identified by unique usernames and passwords, may contain contact information, statuses and preferences. Users essentially represent participants (i.e., host and users) who are system users of the OM System 100. Each user is preferably associated with at least one Enterprise and has access to one or more Enterprises. Enterprises provide both context for the user and information, including the view of catalogs, pricing associated with each product and available ordering options, such as payment method, bill-to and ship-to addresses, credit limits, approval workflow and promotions. Users may be enrolled either into a specific Enterprise themselves or are enrolled by, for example, an administrator.

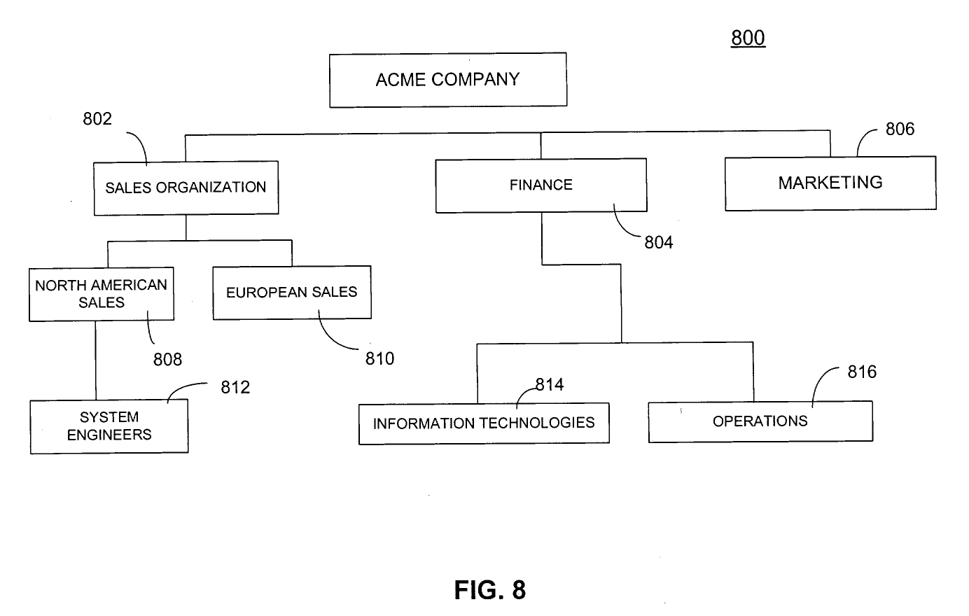

An Enterprise is the highest entity representation in the OM System 100. The OM System 100 may support a tree hierarchy for Enterprises to facilitate a multi-level organization. FIG. 8 is an organizational chart 800 for an exemplary buying company. In this example, the buying company consists of multiple departments and divisions 802 to 816. The organization chart 800 having a hierarchical structure whereby the organization is structured with three layers of departments or division one on top of another. The first layer consists of sales organization 802, finance 804 and marketing 806. The second layer consisting of North American sales 108 and European sales 810 for the sales organization branch, and information technologies 814 and operations 816 for the finance branch. Finally, system engineers 812 making up the third layer for the sales organization branch. Enterprises may also be arranged hierarchically, with no limit on depth, and may mirror a company's organizational structure such as illustrated in FIG. 8. Each Enterprise may have separate credit limits and other Enterprise specific attributes. Users may be enrolled into one or more Enterprises with no limit on how many total Enterprises into which they are enrolled. The Enterprise hierarchy may be created to match the buying organization's structure. Users at the lower level of the Enterprise hierarchy inherit functionality from their parent Enterprises. So to grant permissions for functionality in a multi-tiered organization, users enrolled in the lower level Enterprise will inherit the permissions of the parent Enterprise so that they do not have to be granted these permissions individually. A user at a higher Enterprise can only grant those privileges to which he has access rights. Typically, the top-level Enterprise is used to set up global information and to allow customer service representatives global administrative access.

Only users having Enterprise administration privileges may access the Enterprises administration interface. If the privilege is not granted, the Enterprise administration interface may not be accessed.

When an Enterprise is created, a number of attributes may be created initially and/or in the future. These attributes may include, for example, Enterprise name, Enterprise description, Enterprise type, location with Enterprise hierarchy, payment method, enterprise status and address information. Each Enterprise will preferably have a unique name. The Enterprise administrator may specify the Enterprise name when the Enterprise is created. Each Enterprise will preferably have a unique description. The Enterprise administrator may specify the Enterprise description when the Enterprise is created. An Enterprise may have an attribute for payment method. Such an attribute may be used to indicate an acceptable payment method. For example, the method type that may be available includes, for example, accounts payable (preferably including information related a credit limit and a payer address) and credit card. Another attribute that may be assigned to an Enterprise includes an attribute called “Enterprise status.” A number of statuses may be created. For example, a status called “active” which indicates that the Enterprise is active. A status called “suspended,” which prevents any action from being performed against the Enterprise (access to the Enterprise may be limited to administrators). A status called “cancelled,” which indicates that the Enterprise is ready for deletion, and the Enterprise status may not be modified (not displayed to users). The status of an Enterprise will preferably not be changed to “cancel” once an order has been placed against the Enterprise. And finally, an attribute called “address information” may be associated with an Enterprise. The address information may be created by an administrator during the Enterprise creation process and may be edited by the administrator for the Enterprise. Information that may be included in this attribute includes, for example, contact address and/or person/business, billing address and/or business/person, shipping address and/or person/business and payer (the payer address type may not be required if the enterprise does not have the account payable payment type. If the Enterprise has the account payable payment type, then the Enterprises may have multiple payer addresses. Clearly, many other attributes may also be included.

Sub-Enterprises for each Enterprise may be created. Such sub-Enterprises may be created by the administrator[s]. The administrator[s] may have the same privileges in child Enterprises as they do in the parent Enterprise.

According to one embodiment of the present invention, security and access may be provided via login/password security roles. Generally, each system user may be provided with a user name and password to securely identify them. By incorporating roles, individual companies (i.e., system users) may directly control who has access to various data stored in the system's database. Roles determine each user's specific privilege/access to various functionalities. For example, permission or authorization to view prices, submit orders, view product information, view order status, perform drop-shipments, manage users and accounts, administer configurations, administer order approval rules, can all be controlled at the User or Enterprise level. Lower level Enterprises may “inherit” a higher-level Enterprise's access privileges if desired. To illustrate, suppose two roles “123” and “234” are created and assigned to specific users. Role 123 is a higher-level role than the lower-level of role 234. This, in turn, allows an administrator to define default behavior (for example, all users with role 123 can view inventory, but user XYZ with role 234 can order, view inventory and check order status). Commonly used roles include orderer, approver and supervisor.

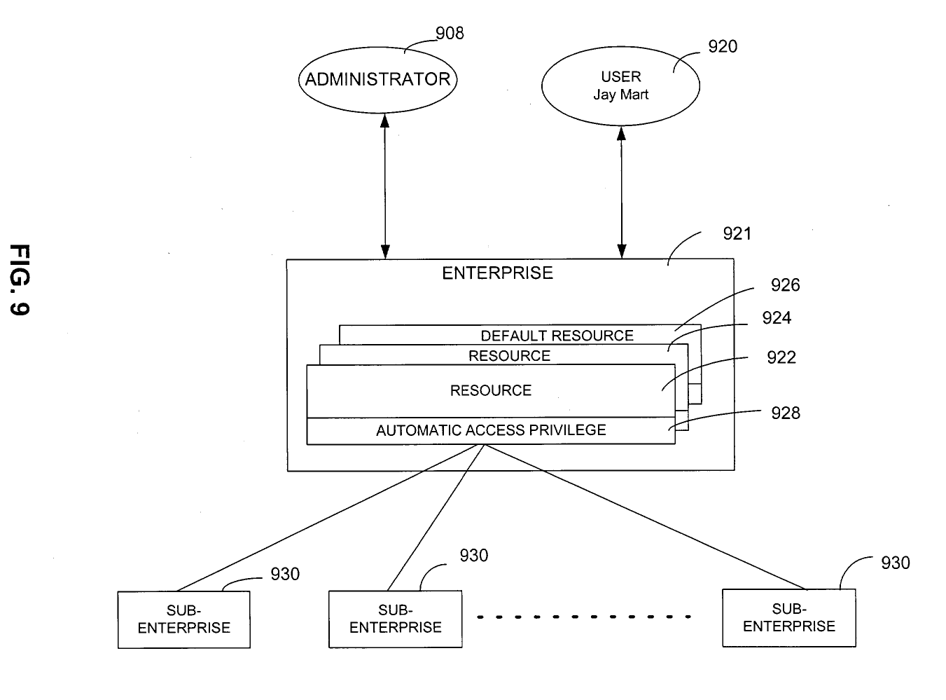

A user may be associated with an Enterprise by various means including, for example, enrollment and automatic access privilege. A set procedure is typically used to associate a user with an Enterprise (e.g., identify user, identify Enterprise, associate identified user to identified enterprise, etc.). After a user has been enrolled into an Enterprise, the user may be able to access sub-Enterprises of the original Enterprise. This may be accomplished via automatic access privilege, which automatically grants the user access to one or more of the sub-enterprises. Referring to FIG. 9 which illustrates the relationship between an exemplary user 920 named “Jay Mart,” its associated Enterprise 921 and sub-enterprises 930. In this example, the user 920 is enrolled into Enterprise 921. An Enterprise may have zero or more resources associated with it. A resource is a feature. As described above, features are items that can be turned on or off such as returns. In this case, there are three resources 922, 924 and 926 associated with the Enterprise 921. Because the user 920 is enrolled into Enterprise 921, it is granted a resource 922 that contains the automatic access privilege 928. Further, the user 920, Jay Mart, is associated with Enterprise 921 and all of the sub-Enterprises 930 that form a sub-tree where Enterprise 920 is the root. If the automatic access privilege 928 is removed from the resource 922, the user 920 is then associated with only enterprise 921 and is no longer associated with any of the sub-enterprises 930 of enterprise 921.

The user's ability to access various data will depend upon the overall privileges of the user. A user's overall privileges are determined hierarchically starting with the resources that are assigned directly to the user, assigned to the user's Enterprise, and the role assigned to the parent account. To illustrate the relevancy of the hierarchy, suppose an Enterprise does not have resources assigned to it. In such a situation, the Enterprise may use its parent's resources (if it is a sub-Enterprise). Generally, it is preferable that a default set of resources 926 exist at the root level. The root level is the level in which the matriarch of an account tree is located. Typically, a user is assigned to only one set of resources in an enterprise.

The following example, together with FIG. 9, illustrates how a user's privileges may be determined. Suppose a user 920 enrolls into an Enterprise 921. If a resource set 922 and 924 in the Enterprise 921 is assigned to the user 920, then those resources 922 and 924 become associated with the user 920. If no resources have been directly assigned to the user 920 then the user 920 is assigned to the default resource set 926. Of course if the resource sets 922 and 924 that the user is assigned to has an automatic access privilege 928, then the user 920 will have privileges to the sub-Enterprise 930. If the Enterprise that the user 921 is associated with is actually a sub-enterprise and if no default resources exist in the sub-enterprise 930, then the parent enterprise's default resources 926 is assigned to the user 920. Thus, it is strongly preferably that the matriarch of an account tree have default resources. Thus, a user who is enrolled into an Enterprise will generally always be associated with a resource set.

The OM system 100 provides catalog functionalities. The catalog functionalities may be available in either a buy-side or sell-side environment. The system is capable of allowing seller/host to provide catalog access to buyers in a sell-side environment, which is the typical scenario. However, the system may also allow buyer/host to access catalogs of sellers in a buy-side environment. In a buy-side environment, a buyer is the administrator/host and will have relations with one or more sellers. The system may allow such a buyer/host to access catalogs of sellers. Such functionality may be accomplished by, for example, using mapping techniques. For instance, suppose a buyer/host does business with sellers A and B. If the buyer host implements the catalog function and is able accesses the catalogs belonging to both seller A and B. Suppose further that the buyer/host is interested in acquiring an item with buyer's parts number “xyz.” Each of the sellers may have different parts number for the same item (e.g., seller A may have parts number “123” for the same item while seller B may have parts number “456” for that item). In order for the buyer/host to be able to obtain and view the correct information contained in the catalog data, mapping should be performed between the “xyz” parts number of the buyer/host to the “123” and “345” parts number of seller A and B. Alternatively, an unsophisticated buyer/host could use the same parts number of a supplier thus not requiring any mapping.

The catalog sharing function provided by the OM System 100 may allow participants the ability to create, store, update and share one or more catalogs. The OM System 100 allows for the updating of stored catalogs as often as necessary without the need to take the OM System 100 offline. Updating may be accomplished through either the use of an automated loader program or through a manual editing function. The automated loader update imports the data from a seller's back-end system[s] into the OM System 100. The loader may simply read the seller data, map it to the OM System's database schema and then insert the data into the application's database. These loaders may be simple or complex depending on the structure and location of the back-end data. The loaders typically handle both total catalog refreshes and incremental changes. The OM System 100 may also import catalog data from data files. These files may contain the data in many different formats including XML.

Each item listed in a catalog may include an associated graphic that provides a visual image of a catalog item. Graphics can be any file type that the browser being used can read. Typical file types are JPEG (Joint Photographic Experts Group) and GIF (Graphics Interchange Format). The system may also include the ability to play a streaming sound and/or video file for a catalog item.

Preferably the OM System 100 can manage multiple catalogs. A buyer's access to catalog[s] may be restricted based on enterprise and/or user. A user with access to multiple catalogs may move from catalog to catalog and may create a single order with items from multiple catalogs.

The OM System 100 may provide for a search interface, which allows buyer[s] to search for specific items in the catalogs accessible by the user. The OM System 100 may provide searching capabilities, which allows buyer[s] to search for specific items based on, for example, vendors. If necessary, buyers can specify different order information such as purchase order numbers, for each sub-order. As a result, each sub-order is directed to its designated system.

The entry of data for creating a catalog (which roughly corresponds to step 306 of FIG. 306) typically begins by giving the catalog a unique identifier name that serves as the external identifier for this catalog. This allows both seller[s] and buyer[s] to search for and find the specific catalog. Preferably an effective date will also be assigned to each catalog created. This is the date that the catalog is to be effective. The effective date may be an editable field in case the catalog administrator (typically the seller) is creating the catalog in advance and the effective date changes. Of course, alternatively, rather than or in addition to an effective date, an effective time period or termination date may also be defined. Other information that may be entered when a catalog is created includes, but is not limited to, catalog description. Ownership of the catalog is determined by the Enterprise the administrator is logged into when the catalog is created. It determines the visibility of the catalog within the administrative areas of user interfaces. This may prevent the modification or use of a catalog by administrators from other business units within the host seller company. The ownership of the catalog will preferably not affect the visibility of the catalog within the product areas.

The OM System 100 may allow suppliers to set flexible pricing for each item listed in their catalog. A pricing engine may be incorporated into the OM System 100 that allows suppliers to set base prices per catalog, define base price discounts, define time phase pricing and assign different prices per enterprise or user. Such an engine allows greater flexibility in providing optimal pricing for any item listed in a catalog.

To establish pricing for each item in a catalog, a price list may be created. To create a price list, a catalog must be selected. A unique name and an effective date may then selected for the price list. The actual prices are not set up in the price list. Rather, when a product is defined in the OM System 100, a standard price such as the manufacturer's suggested retail price (“MSRP”) is then specified in the price list. The price list may be used to apply different pricing rules/algorithms. However, an administrator may assign a price code when creating the price list. The price code maps to a pre-defined pricing algorithm, for example—a discount formula off of MSRP. A list of pricing algorithms is pre-defined in the product.

Once the list of pricing algorithms is defined, it may appear as a price formula on the user interface, in this case, the seller's user interface. The user, in this case, the administrator of the catalog, must determine which price formula to apply to each price list. The rule values (for example, in the above example the amount of the percent discount) may be edited. Further, the price list may be defined as a discount percentage, which may be changed anytime after the list has been initially created. Multiple price lists for the same time period may be created and the system may be configured to select the price list that gives a user the lowest price and apply that price option. In addition to assigning a name and a catalog (non-editable information) a price list may be associated with editable information such as effective date, obsolete date, description, the price code in effect and the values within the price codes.

The OM System 100 may also allow the creation of information association with parts available through the OM System 100. The parts information that may be stored includes, for example, part number, manufacturer part number, description, UPC, MSRP, the name of the manufacturer, effective date, alternate part number, long description, keyword[s] and obsolete date. Information about a part may be divided into two types of information. The first type of information is catalog independent part information. This type of information is independent of whichever catalog that the part is associated with. For example, part name/number, part description, manufacturer's name and base price are all the types of information that may be independent of catalog. The second type of information is catalog dependent part information. Examples of this type of information are catalog specific price and effective and obsolete dates.

To create a parts catalog, a catalog may be created or a pre-existing catalog is selected. After the catalog is created, select the parts that will be included in the catalog. Generally, only the MSRP or other base price may be available for each part listed and any discounts that may apply to the catalog. Finally, catalog specific (dependent) information may be assigned to the catalog.

Prior to an order being processed (i.e., fulfilled), some businesses may want approval[s] from, for example, senior managers or corporate purchasing personnel. The OM System 100 may provide capabilities for routing orders through multiple levels of approval using approval rules. This automated workflow eliminates costly paperwork and manual procedures for the customer and ensures that only authorized orders are submitted. The approval requirements for specific orders may be defined within an approval profile. Approval profiles may then be applied to, for example, the following instances: an enterprise (where each person within the enterprise is affected); a user (where only a specific user is affected); and a user and an enterprise (where a specific user within a specific enterprise is affected). Approval rules may require approval from a single level or multiple levels of authority. These rules may be based on the monetary amount of the order. For example, if a user's order is more than $500, order approval may be required. Multiple levels of approval may be required and may occur sequentially and/or in parallel. For example, the system 100 may require that the user's order must be approved by two levels of the organization regardless of the value amount of the order before the order is process. However, if the same order exceeds $500, then the system may require that the order be approved at one level prior to processing the order. If it exceeds $5000, a second level of approval may be required. When an order is submitted that requires approval, the buyer receives a message to that affect. An order may be approved by submitting the order to the approving party and once the approving party has approved the order, resubmitting the order back to the order originator. The approving party may include comments into the order when the order is being approved. Once the order is approved, notification may be made to the order originator via, for example, email.

The OM System 100 may provide ERP functionalities such as the creation and processing of purchasing orders. The ERP functionalities allows users to create an audit trail for orders so that orders may be tracked. The ERP functionalities may be available in both sell-side and buy-side environments. Users may also elect not to use such functionalities even though it is available. Various approaches for creating and processing orders may be implemented. In one exemplary process, the first step in purchasing items using the OM System 100 is to create order forms (i.e., order interface). The form[s] may be displayed on a buyer interface. Such form[s] provides the buyer the ability to enter specific information needed to complete the ordering transaction. Preferably the order form is created prior to a buyer submitting a completed order. The order form may be customized to fit the needs of each buyer and/or seller. Alternatively, a predefined order form may be used. If a predefined order is used, it may be further customized to fit the buyers and/or sellers needs. Once the order form is created, it may be saved and assigned to the buyer and/or seller who created the form and to anybody else who may need to use such a form. After a form is created, a buyer having access to the form may purchase an item by completing the form. Once completed, the form may be saved and/or submitted to the appropriate seller[s] for fulfillment. A saved partial or completed order form may be used for purposes of record keeping and/or to use in future purchases as a basis for a new order.

Even after an order form has initially been created, the OM System 100 may allow buyers to customize the order. Buyers often demand flexibility when creating orders. The OM System 100 can provide this flexibility by offering various options when creating an order. For example, buyers may select from a list of valid order payment options set up for their accounts. Some examples of order payment options include account billing and credit card payment. A credit limit may be set up by a seller, which helps to control the amount of credit extended to a customer when using the account billing method. Each time an order is submitted, the amount of available credit in the account may be checked and if the order amount exceeds the amount of available credit, the order may be rejected. Other options are to accept the order but place it in a hold status until approved by the selling company or until the account's credit limit or available credit amount is adjusted by the selling company. A buyer's account information, including credit limit, and available credit, may always be kept up-to-date through a real-time connection to a back-end system. Buyers may also be given an option to choose where the purchase item is to be shipped. The account that the order is associated with may already designate a shipping location or a number of shipping locations that the customer may choose from. The buyer may select one of the defined shipping locations identified in the account or the buyer may choose another shipping location.

An order may comprise of a number of line items. Each line item within an order may be uniquely independent from other line items within the same order in terms of order options and other attributes. The types of options that may be specific to each line item includes, for example, different purchase orders for individual line items on the same order, submission of individual line items on the same order to more than one back-end system, different payment method and delivery method for individual line items on the same order, different bill to, ship to, and payer addresses for individual line items on the same order, different ship dates and delivery dates for individual line items on the same order, different comments for individual line items on the same order, and different statuses for individual line items on the same order.

When a buyer submits an order, the order is generally integrated into the seller's back-end system(s). Various methods may be implemented to accomplish this task. One method is through an order management application gateway that is custom designed and built for each buyer. The nature of the gateway varies depending on each client's backend system and can range from APIs, to sockets, to file transfers. The method is typically limited more by what is available from the back-end systems than what the application hardware, software, and operating system can support. Another method for moving orders from the OM System into a seller's back-end order process is to leverage an existing Electronic Data Interchange (EDI) capability. For instance, the EDI system as described in co-pending commonly assigned U.S. patent application Ser. No. 09/927,412, which uses batch loaders, may be used for such purpose. To gain the full benefits of an electronic commerce ordering system, it is important to realize that a company does not have to choose between the Internet or the EDI. A third method that a seller can use to receive orders created in the OM System 100 is through a “rip and read” process. Orders created in the OM System may be sent through an email or fax server so that the seller receives the orders as part of an email message or fax. Some companies may choose to use this feature in addition to providing salespersons and/or third-party logistics partners with a view to incoming orders.

After a buyer has submitted an order, the order is then transferred to and received by the seller. Typically when a buyer submits an order, the buyer generally wants to know that the order was received by the buyer's back-end system and if the seller can meet the requested quantities and dates specified on the order. This may be a two-step process where the customer first receives an acknowledgement that the order was received by the buyer's back-end system and later receives a confirmation that the order can be fulfilled as requested. However, in many cases, the back-end system may provide fulfillment information immediately and the buyer may only receive a single confirmation. The OM System 100 may support either of these environments. In either case, the OM System 100 may provide the buyer with an online acknowledgement/confirmation and an email option. The information provided in the confirmation may be customizable depending on the information available in the seller's back-end system. The OM System 100 also provides a supplier workbench where suppliers can log on and manually confirm or fulfill an order. The supplier has the ability to accept or reject any orders coming from the buyer.

The OM System 100 may provide an order-tracking feature that may be integrated into a seller's back-end system(s) to provide real-time order status information. Various methods for accessing the status of orders may be used. For example, the OM System user interface may be configured to display the last in number of submitted orders along with each order's status. Additionally a link to the order may be provided. Alternatively, according to another embodiment, order status may be accessed by using a search engine to find the order. Search criteria that may be used may be configurable and may include, for example, part number, the tracking code from the OM System, order status, order date (range), purchase order number, tracking number (from back-end system) and account. After locating the order, a user may drill down for the status of each line item within the order. Available information that may be included includes, for example, status of line item, estimated time of arrival for back-ordered items, total order cost (including tax and shipping fees).

The OM System 100 accommodates purchase item returns (processing as indicated by the returns module 114 in FIG. 1). Returns functionality, often referred to as reverse logistics, enables buyers to enter information about a specific return and request return authorizations. Additionally, this feature may allow sellers to process return information, accept or deny requests, and issue return authorizations. Generally, returns require different information than an order. The information requested on a return may be configured to fit the needs of the supplier and/or buyer. Information that may be included in a return includes, for example, return code, purchase order number, partial or complete return information, quantity and item number(s), reason for return, and the like.

The returns functionality of the OM System 100 may be implemented in a number of ways. For example, to provide return capabilities, generally the seller and/or buyer creates a return form. The return form will generally require the buyer to provide specific information such as those described above. When a buyer seeks to return a purchase item, the buyer simply retrieves a form and submits the form to the appropriate seller(s). The seller may set ground rules, which determines when returns from buyers may be submitted to the seller. For example, a seller may refuse to accept any returns if the date of the return is beyond a certain date after the purchase or delivery date. Once the return is, however, received by the seller, a message may be sent to the buyer acknowledging the receipt of the return. The notification may be made in a number of ways including notification via the buyers' user interface, email, and the like.

The reason for the return is generally included in the return when a return is submitted. The reason for the return may be indicated by using return codes. These codes may indicate, for example, that the purchased item was dead on arrival, warranty replacement return, ordered the wrong item, ordered the wrong quantity, and the like. These codes may trigger a series of business rules created by the seller(s). For example, if the buyer enters the return code “Dead on Arrival,” after the product is received, a credit of the original purchase price may be applied to the payer account. If the product is tested and no trouble is found (“NTF”) then a x% fee may be applied to the payer. Another option is to charge a flat fee, similar to a returned check fee, if the returned product is not defective. If, on the other hand, the return is for a warranty replacement, different rule(s) may apply. For example, once the item is received and the warranty period has been validated, the replacement may then be immediately shipped without some of the steps implemented under the dead on arrival return code designation.

The OM System may allow sellers to create and display surveys to buyers. Buyers may complete the surveys and submit the completed surveys back to the seller(s) via, for example, the Internet. Surveys that are created and displayed on the buyer interface may contain a variety of questions and answer types including, for example, online text, multiple line text, multiple choices and multiple choices with drop down selection. The survey responses may be saved in the OM System database 102 and may be reported on using a reporting tool. In addition, after a survey is completed, an e-mail can be automatically generated to a customer satisfaction address so that the results may be recorded and evaluated.

Several methods for obtaining surveys are possible. One approach for getting surveys from buyers begins when a seller creates a survey and assigns an expiration date to the survey (if it is a time-phased survey). A seller may also create multiple surveys to hold in the database 102, which may be revised with alternate dates. The seller may also specify which buyers should receive which survey or indicate that all buyers should receive the same survey. For global buyers who use the OM System 100 in multiple languages, the seller must create the survey in multiple languages. Once the survey is created, it may be submitted to buyers via the buyer interface. The buyer may have a choice of either responding to the survey or not responding. If the buyer chooses to respond to the survey then, for example, an Internet hyperlink may be provided in the buyer interface, which allows the buyer to access the survey. Once the buyer completes the survey, it may be submitted back to the seller or may be cancelled. The survey may also be submitted incomplete if desired. After receiving the completed survey, the survey may then be sent to the seller's server where it may be held in a database and may be accessed by, for example, a report-writing tool such as the system described in copending commonly assigned U.S. patent application Ser. No. 10/059,055.

A supplier will typically defined the rules for a buyer who wants to make changes to orders that have already been submitted to the supplier. This may be especially important when the OM System 100 is operating in a buy-side environment as illustrated in FIG. 2B. That is, in the purchase management mode as illustrated in FIG. 2B, the relationship between the various parties is a one-to-many scenario whereby a buyer has a relationship with a number of sellers. Each seller will typically have its own policy regarding the ability of individual buyers to make changes to an order that has been submitted to the seller. This may actually be dictated by the back-end system of the individual seller. As a result, whether a host-buyer will be able to make changes, including canceling, to an already submitted order may depend upon the supplier's backend system or may be dependent upon any rules created within the OM System 100 by either the seller and/or the buyer-host. Of course, these points will also be applicable to sell-side environment such as depicted in FIG. 2A whereby the host is a seller.

A seller should provide relevant information when the seller sets canceling and order change rules. Information such as when order changes are allowed based on dates, time periods, product lines and cancellation policies. Sellers may also determine which information contained in an order should not be editable per site, account, or any other attributes. Other specific rules may also be defined by a supplier such as whether a buyer may be able to edit specific line items and if so, whether the buyer may be allowed to delete the line item altogether.

The OM System 100 according to the present invention may provide a request for quotation (“RFQ”) feature, which allows buyers to submit a request for product quotation from a suppliers. Each seller may require that certain information, for example, product number and description, be provided in the RFQ. The seller may also require that the buyer provide information related to other user-defined attributes. A buyer may also choose to voluntarily provide non-required attribute information. Such capabilities may be especially beneficial in a “request for build” scenario whereby a buyer is requesting a customize product or part and no product identification such as item number is available. In such situations, a buyer will typically submit a RFQ rather than an order. A buyer may use the RFQ to request for a new price for a product already listed and having a listed price. This scenario may occur for example when a buyer finds other suppliers selling the same item at a lower price and seeks to obtain the item at the competitive price offered by the other suppliers.

Once a buyer submits a RFQ and receives a quote back from the seller, the seller may then limit that negotiation process to one “round” and essentially not continue the iterative process. Otherwise, the seller may choose to further negotiate with the buyer. Either way the decision to further negotiate may be indicated and determine by providing relevant information in the RFQ and/or the quote from the supplier in response to the RFQ.

The OM System 100 may allow buyers to check for availability of items with specific suppliers. This may be accomplished, for example, through RFQ by listing in the desired items' supplier product number into the RFQ.

The quotes may be time stamped which restricts the validity of the quote to a specified time period. That is, the time stamp defines a time when the quote becomes invalid. The quote will preferably have the time stamp listed so that when the buyer views the quote the buyer is able to determine when the quote expires. The quote may also include a comments section that allows sellers to include comments. The comments section allows buyers to view comments by the seller, which may be useful when trying to determine the reason for the seller's quote.

The quote may contain a status indicator. The status indicator indicates the status of the quote. For example, if the buyer chooses to reject a quote by a seller, then the buyer may change the status from, for example, “pending” to “rejected.” The seller may then view the status of the quote by, for example, using a monitoring application such as described in co-pending commonly assigned U.S. patent application Ser. No. 09/984,340.

The OM System 100 may provide a forum for negotiations if the buyer rejects a supplier's quote. When a supplier and/or buyer decide to renegotiate, the negotiation may be conducted within the quote that was provided by the supplier. For example, once a buyer has rejected the supplier's quote, the rejection will be indicated by the status of the quote. After discovering that the quote has been reject based on the status indicator, the supplier may then have an opportunity to re-quote or they may choose to ignore the rejection.

Once the buyer has accepted a quote, an order may be generated by the OM System and submitted electronically to the supplier. The supplier's procurement application, such as described in co-pending commonly assigned U.S. patent application Ser. No. 09/984,340, may then generate a delivery order (“DO”) based on the electronic order submitted by the OM System 100.

The OM System 100 may provide a target market feature, which may be an Internet-based marketing tool providing a capacity to track and understand customers' activities and needs, market and offer promotions on products and services that meet those needs, and measure the success of these marketing efforts. Several methods using various steps may be used to provide target marketing capabilities.

One approach to target marketing or personalized marketing is to develop customer profiles. Customer profiling allows a seller's (a seller may be a manufacturer, a distributors, a retailer, and the like) marketing department to track various activities. The collection and profiling of account and user information is one of the integral pieces in the successful implementation of targeted marketing. Profiling data may be used specifically for personalization, personalized marketing and analysis, and reporting on the buyers both individually and in the aggregate.

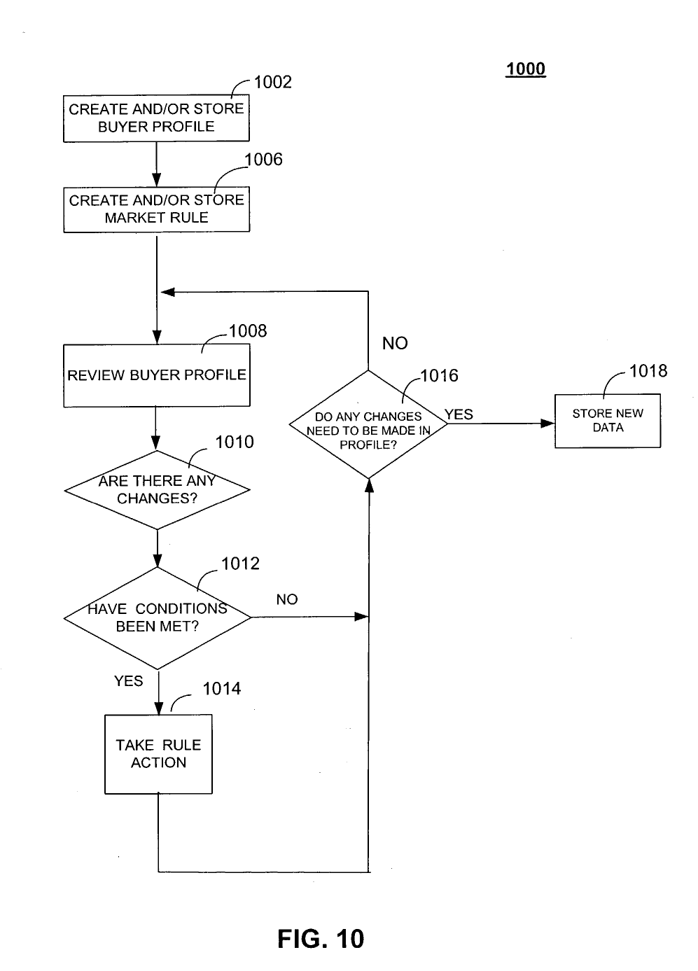

Several methods of implementing target marketing are possible. FIG. 10 is an exemplary process 1000 for target marketing. The process 1000 begins when initial buyer profile[s] are created and/or stored at step 1002. The initial profile may be preexisting and therefore, may be retrieved and stored. Moving to step 1006 where a market rule[s] is created and/or stored. Market rules define the condition that results in a target marketing action being implemented. Market rules may pre-exist and therefore, may simply be retrieved and stored. Next at step 1008, review the buyer profile. During or after reviewing the buyer's profile, determine whether any changes have been made to the buyer profile at step 1010. If changes have been made to the profile than determine whether any rule conditions have been met at step 1012. If true, then take appropriate action at step 1014. If no changes have been made, no rule conditions have not been met or action have been taken than determine whether any changes need to be made in the buyer's profile at step 1016. If true then add new data or amend existing data to the buyer profile at step 1018. Next, return to step 1008 to restart the entire process again. Note that additional steps may be included in this flow process 1000 without deviating from the primary flow process. For example, an additional step for determining whether the process should be terminated based on some condition being met could also be included without deviating from the primary flow process.

Two types of information are generally needed to drive personalized marketing, explicit and implicit information. Explicit information involves information about the end-customer that is already known. Examples include account information, geographic information, channel, contract information, product lines brought, and the like. This information may be identified and recorded during registration either by the buyer and/or by an administrator. Implicit information involves information about a buyer based upon activities and actions that the buyer performs online. Examples include order history and click stream history (for example, what products were searched for, when, and how many times, which promotions were viewed, and which of those promotions resulted in a purchase and which products were viewed).

The implicit and explicit information may be used together to predict and influence a customer's behavior. For example, data captured by the customer profile may be used in at least two ways, sellers (as well as other marketers) can analyze and view this data to make critical business and marketing decisions, and rule conditions, which analyze profile data when a rule is executed determining if the condition has been met and if a marketing action should be taken (e.g., a promotion presented).

Based on rule conditions, existing data and occurring activities are captured and stored in a customer profile database. Again, this data may be referenced when rule conditions are evaluated. The presentation of promotions and other marketing information is based on this data so accuracy and completeness are important.

Various types of implicit and explicit data may be collected for a customer profile. For example, data relating to account, order, product searching, promotional data and the like, may all be collected over time, more information, both explicit and implicit, about buyers may be required to expand the value and usefulness of the marketing capabilities of the OM System 100. In addition, sellers as well as other system users may want to use this data for making important marketing and business decisions. This requires extensive analysis and reporting of the customer profiling data. In order to provide improved performance, a separate profiling database 104 dedicated to storing customer profile data may be included in the OM System 100.

To ensure the integrity and relevance of the data contained in the customer profiles, the data may be updated frequently. Customer activity and transaction history may be captured initially in the system database during normal activities. To move the profile data from the primary system database 102 to the profiling database 104, periodic updates of the profiling database 104 may be scheduled. These can be scheduled once a day, every n hours, every n minutes, or any other appropriate time increments. The frequency of the update may depend on the required level of customer profile data. That is, marketing rules that trigger online and e-mail promotions are typically executed against data in the customer profiling database. Therefore, a specific rule may not trigger an event even though the condition has been met because the data has not yet been synchronized to the customer-profiling database.

An administrator for managing the marketing rules may create market rules that define the conditions to be evaluated and the actions to be taken (i.e., promotions) when specified conditions are met. This may allow a seller to present specific product buying opportunities or promotions targeted to specific customers. Marketing rules are comprised of numerous components including, for example, rule name, effective date, one or more rule conditions, insertion type for the promotion, insertion point for the promotion, action, and the like. In addition to each rule having these components, a rule may be part of one or more rule profiles that are created to identify which rules are executed for which accounts and/or users. The administrator interface may enable the administrator, who creates these marketing rules, to select the various components, define the necessary attributes of the rule, and assign the rule to a profile to create the business rule environment that drives online and e-mail merchandising and promotion activities.

Rules conditions are used to determine when a specific action or actions (e.g., promotion offer) is to take place. Conditions generally are statements concerning various types of information, for example, order history conditions, product conditions, account conditions, current order conditions and online activity conditions. In addition, conditions may include fill-in-the-blank variables.

E-mail messages may be sent based on a one-time established date and time trigger or on a recurring date and time trigger. In addition, an email may be sent on a specific date and time based on other rule conditions.

Rules may be formed that create relationship between two conditions, for example, an “and” or a “or” relationship. When two conditions have such a relationship, the resulting condition is called a “joint condition.” To illustrate, a joint condition may look like the following: account A has not previously ordered product AA and the current order includes the product AB. The result is that unless account A has currently ordered product AB and has not previously ordered product AA, the condition has not yet been met. Two joint conditions may also be connected to form a “component condition” using an “and” or an “or” connector.

Conditions that are used may contain lists of products or product categories. A list may include from a single to n products or product categories.

Once target marketing has been triggered as a result of conditions being met, “action” may be taken. For example, the action taken may be to display promotional information to the targeted buyer. There are at least two ways that promotional information may be viewed by the buyer. First, the buyer may access the promotional information by a hyperlink to a promotional detail page. Optionally, in addition to the link, the buyer's interface may include information about the promotion to provide a preview of the promotion. The link, as well as the preview information, may be displayed, for example, on the buyer's homepage interface, search results interface, order interface, product detail information interface, and the like. Another way to target the promotional information to specified buyers is via email.

To take action, rule action(s) must be defined. A rule action is the action taken when a market rule initiates an action because conditions have been satisfied. Rule action(s) are independent of marketing rules. Rule actions are generally created and maintained separately and are selected to be added to a marketing rule. Rule actions may be created, for example, from a template, from a pre-existing rule action that may be customized, or a completely new rule action may be created. One type of rule action that may be taken is called a promotional action. Various types of promotional actions may be available. These actions may include, for example, product percentage discount, product percentage discount—minimum purchase required, product amount discount, product amount discount—minimum purchase required, order percentage discount, order percentage discount—minimum purchase required, order amount discount, order amount discount—minimum purchase required.

To help provide a better understanding of how promotional actions may be implemented, the following three key concepts are described: promotion key, promotion type and product promotion display. A “promotion key” ties a promotion to the promotion seller's pricing requirement. If pricing is maintained in the seller's back-end system(s), each action may be associated with a promotion key that ties the promotion to the pricing data in the seller's back-end system. If a catalog or a price list is used, then the promotion key need not be utilized.

Generally all pricing activities related to a specific promotion will be tied to this code. For example, when a rule action is created, an action is associated with a promotion key. If the implementation is one where the pricing is coming directly from a seller's back-end system, the promotion key is used to go to the back-end system to get and apply the promotional pricing.

“Promotion type” defines the type of marketing event that may be created. Some promotion types are informal events that do not have an immediate impact on any order in process. Others may be such that they do have an immediate impact on an order that is being created and processed (for example, the order's pricing is affected).

A “product percentage discount” promotion results in an action that offers a percentage off an account's standard price for a particular product or category of products, if ordered. This percentage off is based on each unit ordered (for example, 2% off each unit ordered). For a product percentage discount promotion, the administrator must define two attributes, products or product categories that the discount applies and discount percentage (the percentage to be subtracted from the price of each unit of product for the product(s) listed in the product categories attributes. We turn now to the various types of promotional actions that may be taken.

A “product percentage discount—minimum purchase required” promotion is an action that offers a percentage off the account's standard price for a particular product or category of products, if the buyer orders a minimum quantity of the product (for example, 2% off each if ordering more than 10). For a product percentage discount—minimum purchased required, at least three attributes is preferably defined: product(s) or product category(ies) that the discount applies to; order quantity threshold for the discount (which represents the quantity that must be ordered before the buyer gets the discount on each unit ordered. valid threshold quantities generally must be 1 or more.); and discount percentage (the percentage subjected from the price of each unit of product for the product(s) listed in the products or product categories attribute. If a buyer accepts a promotion of this type and buys the minimum quantity, the OM System 100 may either calculate the promotion price from a catalog price list or retrieve it from the seller's backend systems associated with the product and the promotion.

A “product amount discount” promotion results in an action that results in offering a dollar (or other currency) amount off a particular product or category of products for each product added to the order. This amount off is based on each unit ordered. Preferably at least two attributes will be defined: product(s) or product category(ies) that the discount applies to; and discount amount (the amount subtracted from the price of each unit of product for the product(s) listed in products or product categories attribute. If the buyer accepts a promotion of this type, the OM System either calculates the promotion price from the catalog price list o retrieves it from the seller's back-end systems associated with the product and the promotion.

A “product amount discount—minimum purchase required” promotion results in an action that offers a dollar (or other currency) amount off a particular product or category of products. If the buyer orders a minimum quantity of the product (for example: $2.00 off each if ordering more than 10). Preferably at least three attributes are defined: product(s) or product category(ies) that the discount applies to; order quantity threshold for the discount (represents the quantity that must be ordered before the buyer gets the discount); and discount amount (the amount subtracted from the price of each unit of product for the product(s) listed in product or product categories attribute. If a buyer accepts a promotion of this type, the application either calculates the promotion price from the catalog price list or retrieves it from the seller's back end systems associated with the product and the promotion.

An “order percentage discount” promotion results in an action that offers a percentage off the total order. This percentage off may be based on simply creating an offer (for example, 2% off order). For an order percentage discount, at least one attribute must be defined: the discount percentage (the percentage subtracted from the total order amount). If a buyer accepts an order percentage discount promotion, the OM System 100 performs the calculation as defined, reducing the order amount by the appropriate discount percentage. This discount may be applied against order line items total only (for example before tax, shipping and handling).

An “order percentage discount—minimum purchase required” promotion results in an action that offers a percentage on the total order if the order amount exceeds some threshold. At least two attributes must generally be defined, order amount threshold for the discount and discount percentage. If a buyer accepts an order percentage discount minimum percentage required promotion, the OM System 100 performs the calculation as defined to reduce the order amount by the appropriate discount percentage. This discount is preferably only applied against the order line items total (for example, before tax, shipping, and handling).

An “order amount discount” promotion results in an action that offers a dollar (or other currency if dollar is not the base currency) amount off of the total order. This amount may be based on simply creating an order (for example, $25 off an order). At one attribute, the discount amount (specifying the amount to be subtracted from the total order amount), is preferably defined. If a buyer accepts an order amount discount promotion, the OM SystemOM System 100 performs the calculation defined here to reduce the order amount by the appropriate discount amount.

An “order amount discount—minimum purchase required” promotion results in an action that offers a dollar (or other currency) amount off of the total order if the total order amount exceeds some threshold. At least two attributes will be defined, the threshold amount and the discount amount. If the buyer accepts an order amount discount promotion, the OM System 100 performs the calculations to reduce the order amount by the appropriate discount amount. This discount will preferably only be applied against the order line items total (for example, before tax, shipping and handling).

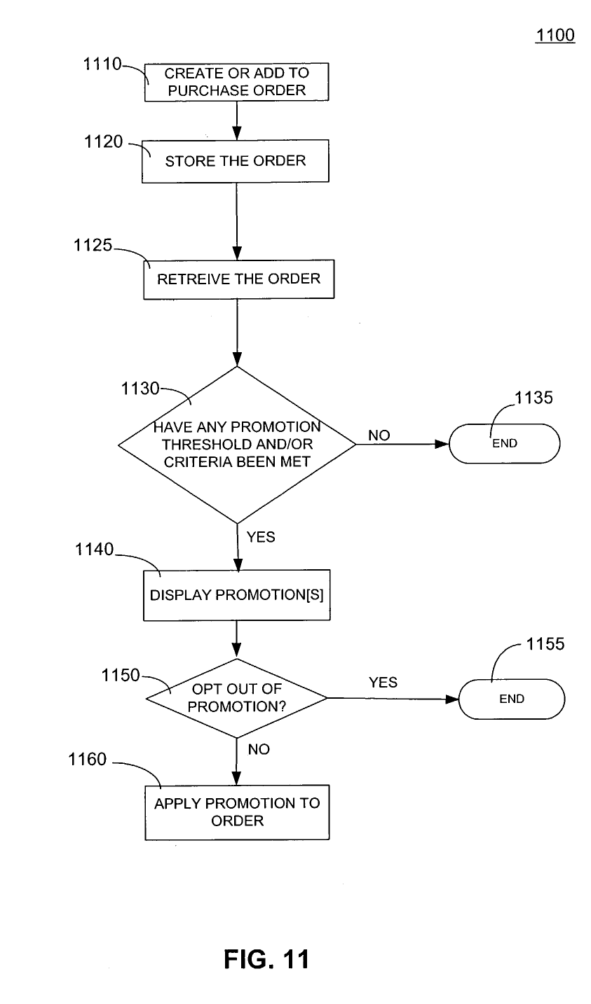

Several approaches for implementing promotions initiated by new orders and/or changes to orders are possible. Referring to FIG. 11, which shows an exemplary flow process 1100 for applying promotions to orders. Initially an order is created or updated at step 1110. Once the new or updated order is created, it is then stored at step 1120. At step 1125 retrieve the order. At step 1130, determine whether any promotion is applicable to the new order or the updated order based on the order and/or external environmental factors. If not, the process ends at 935. If one or more promotions are applicable, allow buyer to view applicable promotions at step 1140. Determine whether buyer would prefer to opt out at step 950. If the buyer opts out of the promotion, the process ends at 1155. Otherwise, the OM SystemOM System 100 applies the appropriate promotion to the order at step 1160. Alternatively, a buyer may also automatically accept the appropriate promotion[s] simply by ignoring the opt out question which may be posed to the buyer through the buyer's interface. If a new order or an updated order qualifies for more than one promotion, various approaches may be taken to resolve any conflict. For example, the buyer may be allowed to view all of the promotions that the order qualifies for and may be allowed to select the promotion to be applied to the order. In another alternative, the promotion[s] that provides the greatest benefit to the buyer may be automatically selected or may be displayed to the buyer.

The OM System 100 may interface with external system allowing the system 100 to seamlessly import and export data from external systems such as a seller's back-end systems. One approach for integrating with external systems is to take advantage of the capabilities of an Enterprise Application Integration (“EAI”) and a Business to Business Integration (“B2Bi”) application that provide much of the functionality necessary to integrate enterprise systems. This approach may heavily rely upon EAI/B2Bi solutions. The approach is to create a single, standard API that enables integration with leading EAI/B2Bi application. The EAI/B2Bi applications provide the capability to integrate with other enterprise systems, including e-marketplaces. Additionally, routing requirements may be satisfied within the EAI/B2Bi applications.

Various approaches may be used to interface the OM System 100 to external applications. For example, a base infrastructure, which may allow the OM System 100, according to the present invention, to interface with external systems typically includes many sub-components. To the extent possible, the OM System 100 may use accepted, open standards that are widely-used in most of today's enterprise applications. Specifically, these include XML for message content and HTTP for message transport. The OM System 100 may leverage the functionality of existing EAI/B2Bi applications. The EAI/B2Bi application may be leveraged for its ability to route messages and integrate with enterprise systems. The EAI/B2Bi solution that may be used may be independent of the application API, although adapters may be available for specific EAI/B2Bi solutions. Thus, a system user, such as a buyer, may use any of the supported EAI/B2Bi solutions to send and receive transactions. Additionally, a system user may build an adapter between the enterprise integration APIs and a non-supported EAI/B2Bi solution using the enterprise integration HTTP pipe.

In order to support both a buy-side and a sell-side solution, key types of system users should be defined as well as partitioning the functionality (from the user interface standpoint) based on those user types by creating specific application views, or “portals” for each type of user. A portal is a gateway or an entrance, which allows system users to log on and manage all aspects of their relationships with other users. There are at least two types of users, end-users and administrators. Depending on whether the OM System 100 is implemented as a buy-side solution or a sell-side solution, the identities of the end-users and administrators will differ. For example, if the OM System 100 is being implemented as a buy-side solution, the administrator will typically be a buyer and the end-users will typically be sellers. If, on the other hand, the OM System is being implemented as a sell-side solution, than the administrator will typically be a seller and the end-users will typically be buyers.

A portal for suppliers (“supply portal”) may allow suppliers to do a number of administrative and managerial tasks. For example, the portal may include the ability to create and/or update parts and pricing, respond to RFQs, accept orders, update delivery and fulfillment data, and process returns and issue RMAs (Return Maintenance (or Merchandise) Authorization. Some of the functionality that may be included in a supplier's portal includes supplier logon, security, partner profile, catalog maintenance, iterative quotes, order change and cancellation, order submission/response/status, returns processing, and reports.

The OM System 100 may allow users to display information formatted to local standards and languages on the user interface. A system user may select a language when the user first logs on. Once a language is selected, some or all of the text data may be displayed in the selected language. This means that information contained in accounts, catalogs, order, and the like, may all be displayed in the selected language.

System users may also select the currency that quantitative type data may be displayed in. Other types of local standards that may be selected includes, for example, specific dialects, appropriateness of product/company names, culture-specific references, values and taboos, color and aesthetics and symbolism (in some parts of the world, the same symbol, such as a check-mark, is used for the exact opposite meaning). Color has a different impact from market to market and is useful for illustrating the differences in convention and experience that underlie the cultural gap. Dates may also be formatted according to local customs. For example, in the U.S., dates are typically written by month-day-year. However, in many countries, it is written by day-month-year.

Regarding the security functionality, suppliers operate in the context of an enterprise. Their security context is the supplier ID, along with the requisite privileges to enable visibility to specific functions limited within their own data domain and to support supplier-centric roles.

Regarding the partnerships functionality, it is generally preferable to set up rules regarding each of the partnerships they are participating in. This includes the ability to order, process returns, publish catalogs, order change, cancellation, quotes, and the like. The rules will define which actions will be allowable and if allowable, will lead the supplier to another page to define parameters around each privilege.

It will be apparent to those skilled in the art that various modifications and variations can be made to the purchase order management system and method of the present invention without departing from the spirit or scope of the invention. Thus, it is intended that the present invention covers the modifications and variations of this invention provided that they come within the scope of any claims and their equivalents.

What is claimed:

1. A method for sharing supply chain information relating to supply chain transactions and marketing capable of being implemented by a supply chain trading partner in both sell-side and buy-side environments, comprising the steps of:
defining a host and users, said host is at least one of a seller and a buyer;
activating at least two functionalities, said at least two functionalities are ERP and catalog sharing functionalities;
creating at least one partnership between said host and at least one of said users, said at least one partnership defining rules relating to said at least two functionalities; and
implementing an action based on one of said at least two functionalities.

2. The method of claim 1, further comprising the step of creating an optional feature.

3. The method of claim 2, wherein said optional feature is at least one of RFP, RFQ, and returns feature.

4. The method of claim 1, wherein said ERP functionality includes order approval.

5. The method of claim 1, further comprising the step of inputting data for said at least two functionalities.

6. The method of claim 1, wherein said step of creating at least one partnership comprises the steps of creating a partnership ID, identifying partnership members and selecting partnership function.

7. The method of claim 6, further comprising the steps of creating a partnership rule and mapping said rule to said partnership.

8. The method of claim 1, further comprising the step of creating a hierarchy.

9. The method of claim 1, wherein said catalog sharing functionality comprises the step of mapping of at least one item.

10. The method of claim 1, wherein said catalog sharing functionality comprises of the step of loading a catalog from a seller's back-end system.

11. A system for sharing supply chain information relating to supply chain transactions and marketing capable of being implemented by a supply chain trading partner in both sell-side and buy-side environments, comprising:
a computer device;
a database in communication with said device; a module for defining a host and users, said host is at least one of a seller and a buyer;
a module for providing ERP functionality;
a module for providing catalog sharing functionality;
a module for creating at least one partnership between said host and at least one of said users, said at least one partnership defining rules relating to one of said functionalities; and
a module for implementing an action based on one of said functionalities.

12. The system of claim 11, further comprising a module for creating an optional feature.

13. The system of claim 12, wherein said optional feature is at least one of RFP, RFQ, and returns feature.

14. The system of claim 11, wherein said ERP functionality includes order approval.

15. The system of claim 11, further comprising a module for inputting data for said functionalities.

16. The system of claim 11, wherein said module for creating at least one partnership further comprises a module for creating a partnership ID, identifying partnership members and selecting partnership function.

17. The system of claim 16, further comprising a module for creating a partnership rule and mapping said rule to said partnership.

18. The system of claim 11, further comprising a module for creating a hierarchy.

19. The system of claim 11, wherein said module for providing catalog sharing functionality is further for mapping of at least one item.

20. The system of claim 11, wherein said module for providing catalog sharing functionality further comprises a module for loading a catalog from a seller's back-end system.

21. The system of claim 11, further comprising of a profiling database.

22. A program storage device readable by a machine, tangibly embodying a program of instructions executable by a machine to perform method steps of sharing supply chain information relating to supply chain transactions and marketing capable of being implemented by a supply chain trading partner in both sell-side and buy-side environments, comprising the steps of:
defining a host and users, said host is at least one of a seller and a buyer; activating at least two functionalities, said at least two functionalities are ERP and catalog sharing functionalities;
creating at least one partnership between said host and at least one of said users, said at least one partnership defining rules relating to said at least two functionalities; and
implementing an action based on one of said at least two functionalities.

23. The storage device of claim 22, further comprising the step of creating an optional feature.

24. The storage device of claim 23, wherein said optional feature is at least one of RFP, RFQ, and returns feature.

25. The storage device of claim 22, wherein said ERP functionality includes order approval.

26. The storage device of claim 22, further comprising the step of inputting data for said at least two functionalities.

27. The storage device of claim 22, wherein said step of creating at least one partnership comprises the steps of creating a partnership ID, identifying partnership members and selecting partnership function.

28. The storage device of claim 27, further comprising the steps of creating a partnership rule and mapping said rule to said partnership.

29. The storage device of claim 22, further comprising the step of creating a hierarchy.

30. The storage device of claim 22, wherein said catalog sharing functionality comprises the step of mapping of at least one item.

31. The storage device of claim 22, wherein said catalog sharing functionality comprises of the step of loading a catalog from a seller's back-end system.
